(19) United States
(12) Patent Application Publication
(10) Pub. No.: US 2025/0324127 A1
(43) Pub. Date: Oct. 16, 2025

(54) EDGE DEVICE VIDEO ANALYSIS SYSTEM

(71) Applicant: ClearObject Corporation, Fishers, IN (US)

(72) Inventors: Craig Pauga, Indianapolis, IN (US); Chase Weaver, Fishers, IN (US); Aaron Nall, Fishers, IN (US); Derek Bleyle, Cicero, IN (US); Tim Gruenhagen, Indianapolis, IN (US)

(73) Assignee: ClearObject Corporation, Fishers, IN (US)

(21) Appl. No.: 18/870,490

(22) PCT Filed: Jun. 2, 2023
(86) PCT No.: PCT/US2023/024223

§ 371 Date: Nov. 29, 2024

Related U.S. Application Data
(60) Provisional application No. 63/348,692, filed on Jun. 3, 2022.

(51) Int. Cl. H04N 21/431; G06V 10/25; G06V 20/40; H04N 21/234

(52) U.S. Cl. CPC H04N 21/4316; G06V 10/25; G06V 20/44; H04N 21/23418

(57) ABSTRACT

A cloud platform has a message broker and a web portal thereon. An edge device connects to the cloud platform and has a camera thereon, memory for storing computer readable instructions, and a processor for executing the computer readable instructions. A video stream comprising a plurality of video frames is captured from the camera. A set of coordinates to define a region of interest is generated to insert into at least one of the plurality of video frames to form a modified video stream. The modified video stream is processed with an inference module to obtain a plurality of inferences. The modified video stream and the plurality of inferences is sent to the cloud platform web portal to display output relating to the modified video stream and the plurality of inferences thereon.

### CROSS REFERENCE TO RELATED APPLICATION

This application claims the benefit under 35 U.S.C. § 119(e) of co-pending U.S. Provisional Application No. 63/348,692 entitled “EDGE DEVICE VIDEO ANALYSIS SYSTEM” filed Jun. 3, 2022, which is incorporated herein by reference.

### FIELD

The present disclosure relates to a video analysis system and, more specifically, to a video analysis system that includes an edge device that captures a video stream, processes the video stream, and pipes the video stream to a cloud for display through a web portal.

### BACKGROUND

An edge device is any piece of hardware that controls data flow at the boundary between two networks. Edge devices fulfil a variety of roles, depending on what type of device they are, but they essentially serve as network entry—or exit—points. Some common functions of edge devices are the transmission, routing, processing, monitoring, filtering, translation and storage of data passing between networks. Edge devices are used by enterprises and service providers.

Cloud computing and the internet of things (IoT) have elevated the role of edge devices, ushering in the need for more intelligence, computing power and advanced services at the network edge. This concept, where processes are decentralized and occur in a more logical physical location, is referred to as edge computing.

Edge devices can be configured to implement machine learning techniques to improve their operation and/or the edge data they generate. In particular, an edge device can build or utilize a model from a training set of input observations, to make a data-driven prediction rather than following strictly static program instructions. For example, a camera device can utilize deep learning models to learn to detect certain objects and capture images of those objects when detected. The ability to recognize similar objects can improve with machine learning as the camera device processes more images of objects. Since edge computing is a new field, there is a need for an improved system that utilizes one or more edge devices with enhanced video analysis capability.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a video analysis system. A cloud platform has a message broker and a web portal thereon. An edge device having a camera thereon connects to the cloud platform, memory for storing computer readable instructions, and a processor for executing the computer readable instructions. A video stream comprising a plurality of video frames is captured from the camera. A set of coordinates to define a region of interest is generated to insert into at least one of the plurality of video frames to form a modified video stream. The modified video stream is processed with an inference module to obtain a plurality of inferences. The modified video stream and the plurality of inferences is sent to the cloud platform web portal to display output relating to the modified video stream and the plurality of inferences thereon.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a block diagram of an exemplary video analysis system in accordance with this disclosure.

FIG. 2 is a block diagram of an exemplary edge device in accordance with this disclosure.

FIG. 3 illustrates an exemplary screen for a web portal in accordance with this disclosure.

FIG. 4 illustrates another exemplary screen for a web portal in accordance with this disclosure.

FIG. 5 illustrates another exemplary screen for a web portal in accordance with this disclosure.

FIG. 6 illustrates another exemplary screen for a web portal in accordance with this disclosure.

FIG. 7 illustrates another exemplary screen for a web portal in accordance with this disclosure.

FIG. 8 is a block diagram of an exemplary video analysis system in accordance with this disclosure.

FIG. 9 illustrates an exemplary process in accordance with this disclosure.

FIG. 10 illustrates a block diagram of a computing system operable to execute the disclosed systems and methods in accordance with this disclosure.

### DETAILED DESCRIPTION

The subject disclosure is directed to a video analysis system and, more specifically, to a video analysis system that includes an edge device that captures a video stream, processes the video stream, and pipes the video stream to a cloud for display through a web portal. The edge device can be hard-coded for each specific use-case and can detect whether an object of interest overlaps a region of interest. The edge device can also overlay graphics relating to the region(s) of interest and the object(s) within the video stream. The system can also provide analytics relating to the regions of interest and the objects within the video stream.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

References to an “app”, an “application”, and a “software application” shall refer to a computer program or group of programs designed for end users. The terms shall encompass standalone applications, thin client applications, thick client applications, web-based applications, such as a browser, and other similar applications.

References to “Internet of Things” or “IoT” shall refer to smart systems and/or devices comprised of physical objects that are embedded with sensors, processing ability, software, and other technologies, and that connect and exchange data with other devices and systems over the Internet or other communications networks. The systems can represent a convergence of multiple technologies, including ubiquitous computing, commodity sensors, increasingly powerful embedded systems, and machine learning.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The subject disclosure is directed to a video analysis system that includes one or more edge devices. Information technology environments can include various types of edge devices. In general, an edge device is an electronic device that can form an endpoint of a network connection. An edge device can be a device on an IoT device that can collect data and exchange data on a network. An IoT device can be connected to the network permanently or intermittently. In some cases, an IoT device can include electronics, software, sensors, and network connectivity components included in other devices, vehicles, buildings, or other items. An edge device can automatically and autonomously (e.g., without human intervention) perform machine-to-machine (M2M) communications directly with other devices (e.g., device-to-device communication) over a network and can also physically interact with its environment.

Multiple edge devices within an information technology environment can generate large amounts of data (“edge data”) from diverse locations. The edge data can be generated passively (e.g., sensors collecting environmental temperatures) and/or generated actively (e.g., cameras photographing detected objects). The edge data can include machine-generated data (“machine data”), which can include performance data, diagnostic information, or any other data that can be analyzed to diagnose equipment performance problems, monitor user interactions, and to derive other insights. The large amounts and often-diverse nature of edge data in certain environments can give rise to various challenges in relation to managing, understanding and effectively utilizing the data.

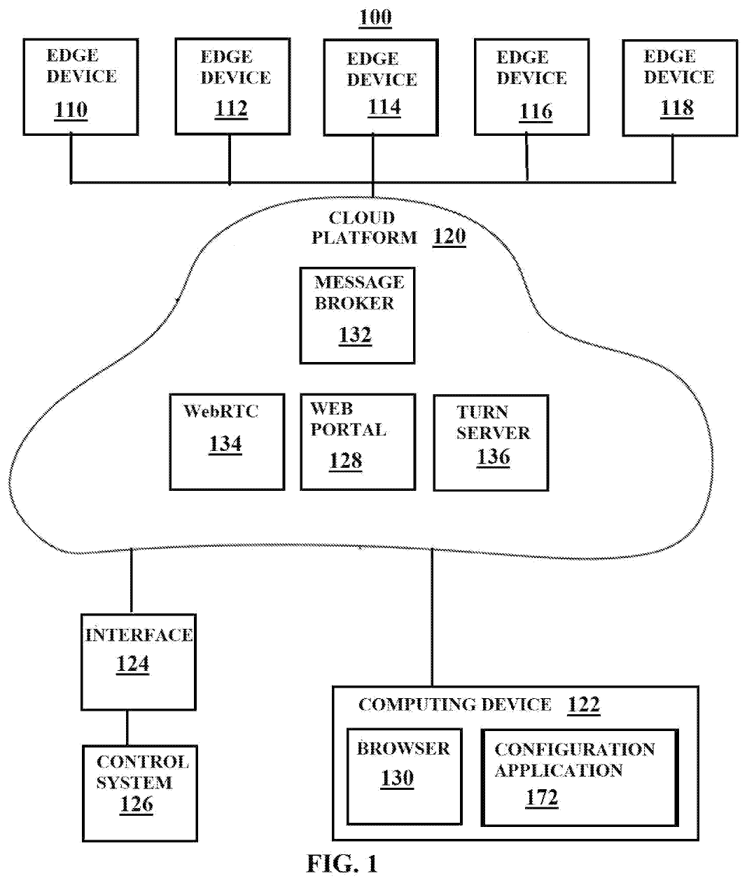

Referring to FIGS. 1-3, a video analysis system, generally designated by the numeral 100, is shown. The system 100 includes a plurality of edge devices 110-118, a cloud platform 120, and a computing device 122. In some embodiments, the system 100 can include an interface 124 that connects to a control system 126. The computing device 122 can be any type of computing device, including a smartphone, a handheld computer, a tablet, a PC, or any other computing device.

The cloud platform 120 connects to the edge devices 110-118, so that the edge devices 110-118 can send an inference pipeline into the cloud platform 120 in real-time. Output relating to the information pipeline can be distributed to the computing device 122 through a web portal 128 and/or through the interface 124 to the control system 126 in real-time. The computing device 122 can display the output on a browser 130 residing thereon.

The cloud platform 120 can include a message broker 132 to mediate the real-time flow of deep learning inferences from the edge devices 110-118 to the computing device 122 and/or the control system 126. The cloud platform 120 can include one or more webrtc enabling applications 134 to facilitate real-time media communication between the edge devices 110-118 to the browser 130 using the Real Time Streaming Protocol (RTSP) protocol. The cloud platform 120 can utilize a Traversal Using Relays around NAT (TURN) server 136 to communicate with the computing device 122.

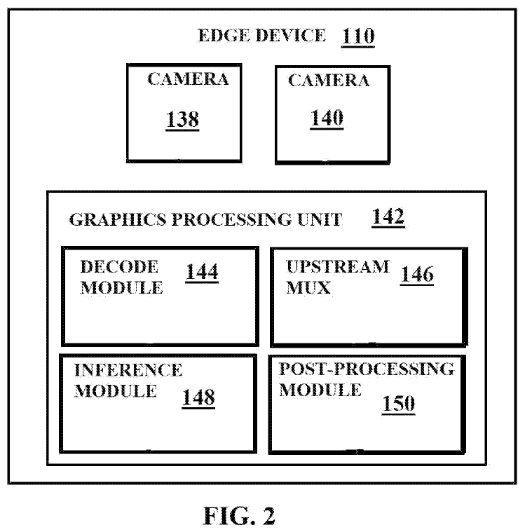

As shown in FIG. 2, the edge device 110 can include a pair of video cameras 138-140 and a graphics processing unit 142. The graphics processing unit 142 can include one or more software applications that utilize artificial intelligence or machine learning to process video signals from the video cameras 138-140, so that processing of the video signals can be performed on the edge device 110 to form one or more video streams that can be piped to the cloud platform 120. The artificial intelligence or machine learning can be implemented through a closed-source library.

It should be understood that while this exemplary embodiment depicts a pair of video cameras 138-140, other embodiments are contemplated that include more than two video cameras.

The edge device 110 can utilize an inference pipeline to send data into the cloud platform 120 in real-time or near real-time. The data can include information that can be used to generate bounding boxes within video streams or other similar information in real-time or near real-time. The edge device 110 can perform segmentation and produce the video cameras 138-140 from deep learning models for the cloud platform 120.

The inference pipeline can include a decode module 144, an upstream mux 146, an inference module 148, and a post-processing module 150 that function as components of one or more software applications on the edge device 110. The edge devices 112-118 shown in FIG. 1 can be configured in the same manner or in a similar manner to the edge device 110.

The edge device 110 can include computer readable instructions that perform various functions thereon. In performing those functions, one or both of the video cameras 138-140 can capture video streams that include a plurality of video frames. The video streams can be sent into the decode module 144 for decoding. In embodiments that include more than two video cameras, each of the video cameras can capture video streams.

The upstream mux 146 can take multiple video streams and combine them into a single video stream, which can be fed into the inference module 148. Then, the graphics processing unit 142 can generate a set of coordinates to edge device 110 can generate a set of coordinates 152-158 to define a region of interest 160 to insert into one or more of video frames to modify the video stream.

The inference module 148 can utilize deep learning models residing thereon to process the video stream to obtain a plurality of inferences. The deep learning models can be a set of node weights that can be trained to detect certain objects within a video feed. The video cameras 138-140 can obtain data for ingestion by the deep learning models to produce output.

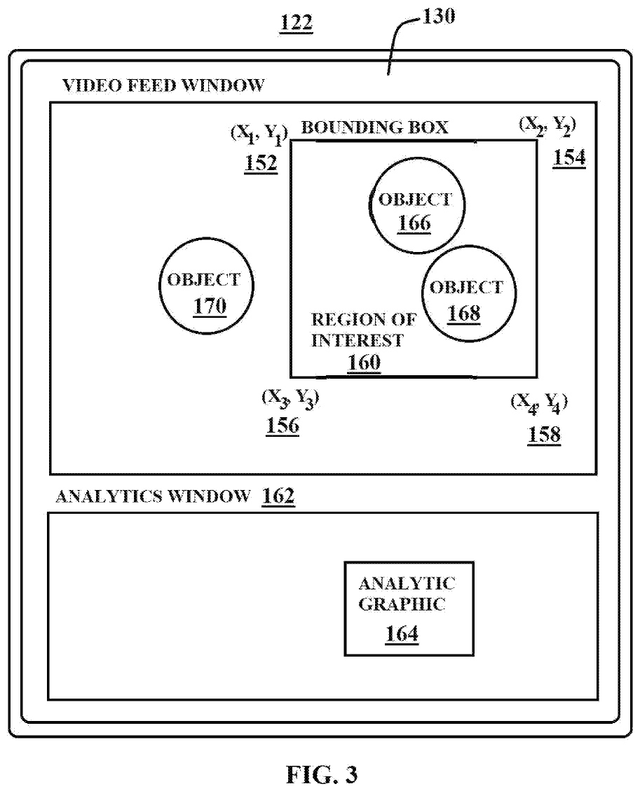

The modified video stream and the inferences can be uploaded or piped to the web portal 142 through the cloud platform 120. The web portal 142 can create output that can be displayed on the browser 130. The output can include the modified video stream and other output relating to the inferences, such as analytic graphics 162 that can be displayed on an analytics window 164, as shown in FIG. 3.

The edge device 110 can be configured to identify objects 166-170 within the video stream. Specifically, the inference module 148 can identify the objects 166-170, determine when the objects 166-168 are located within the region of interest 160, compile statistics relating to the objects 166-170, and segment the objects 166-170.

The post-processing module 150 can perform calculations on the modified video stream. The post-processing module 150 can perform additional machine learning functions on the video stream and can perform classification functions on the objects 166-170 based upon rules. The information can be transmitted as inferences to the cloud platform 120.

The objects 166-170 can be highlighted within the video streams when the video streams are displayed within the browser 130. Similarly, output can be sent to the browser 130 alerting a user that one or more of the objects 166-170 have been detected and/or have been detected within the region of interest 160.

The analytic graphics 162 can include analytics based upon the objects 166-170. These analytics can include the number of objects 166-170 within the region of interest 160. The amount of time that the objects 166-170 are in the region of interest 160. The types of objects 166-170 that are in the region of interest 160.

The analytics can be used in applications relating to analyzing human traffic flow, animal traffic flow, and/or vehicle traffic flow. The analytics can be used to identify hazards and/or to suggest change that should be made to the environment.

In some embodiments, the edge device 110 can insert segments around the detected objects 166-170 when such objects 166-170 are displayed in the browser 130.

The inference module 148 can be configured to identify an event within the region of interest 160. For example, the inference module 148 can review video streams obtained when the edge device 110 is positioned on an oil rig (not shown). The event could include a human entering a particular area.

Then, the inference module 148 can send an alert, an alarm, or notification when it detects an event that could present a health or safety hazard or other danger to the interface 124, so that the interface 124 can shut down the control system 126 or instruct the control system 126 to take other corrective measures.

In some embodiments, the edge device 110 can modify the rules that are stored thereon. The rule modifications can be facilitated via input, by a user, through a configuration application 172 residing on the computing device 122. The configurable application 172 can be used to develop a new deep learning model for transmittal to the edge device 110 and/or to configure rules.

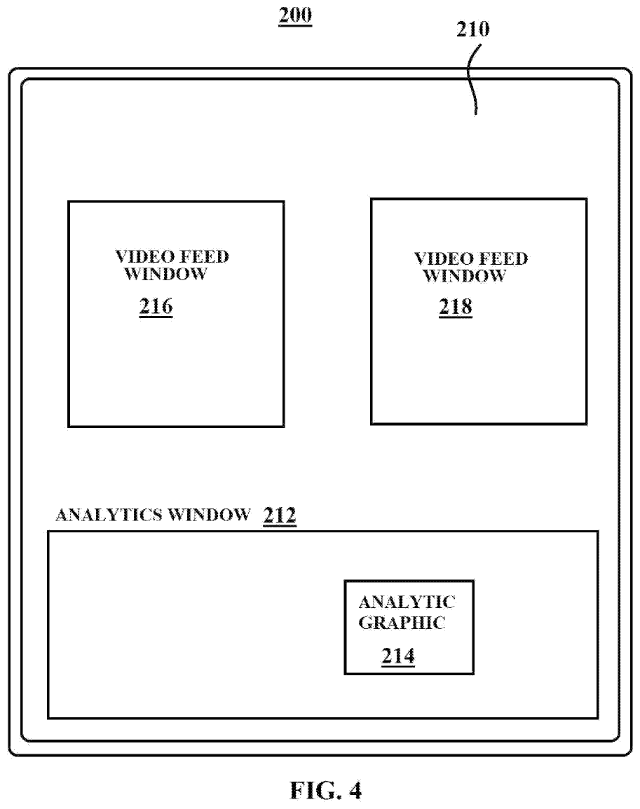

Referring to FIGS. 4-7 with continuing reference to the foregoing figures, exemplary output for various embodiments of a system, like the system 100 depicted in FIGS. 1-3, is shown. FIG. 4 depicts an exemplary screen, generally designated by the numeral 200, is shown. The screen 200 is displayed on a browser 210 that is running on a computing device, such as the computing device 122 shown in FIGS. 1-3. Like the embodiments shown in FIGS. 1-3, the browser 210 displays an analytic window 212 and an analytic graphic 214.

Unlike the embodiments shown in FIGS. 1-3, the browser 210 displays multiple video feed windows 216-218. These video feed windows 216-218 can display video feeds from multiple cameras (not shown) on a single edge device (not shown) or on multiple edge devices (not shown).

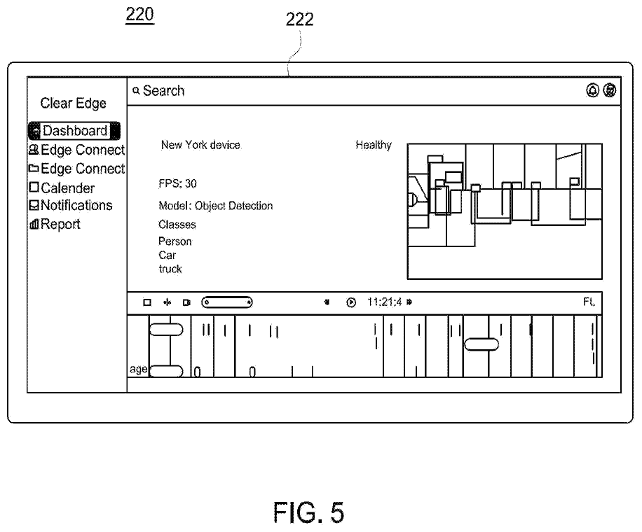

FIG. 5 depicts a screen 220 that is displayed on a browser 222 that is running on a computing device, such as the computing device 122 shown in FIGS. 1-3. The screen 220 illustrates a potential view that a user would see when the user views a one vision system. The screen 220 provides the user with the ability to view an edge device, such as the edge devices 110-118 shown in FIGS. 1-2, to the status of the device, a live stream, models that are applied to a vision system, inference speed, device location, historical prediction information, and other similar output.

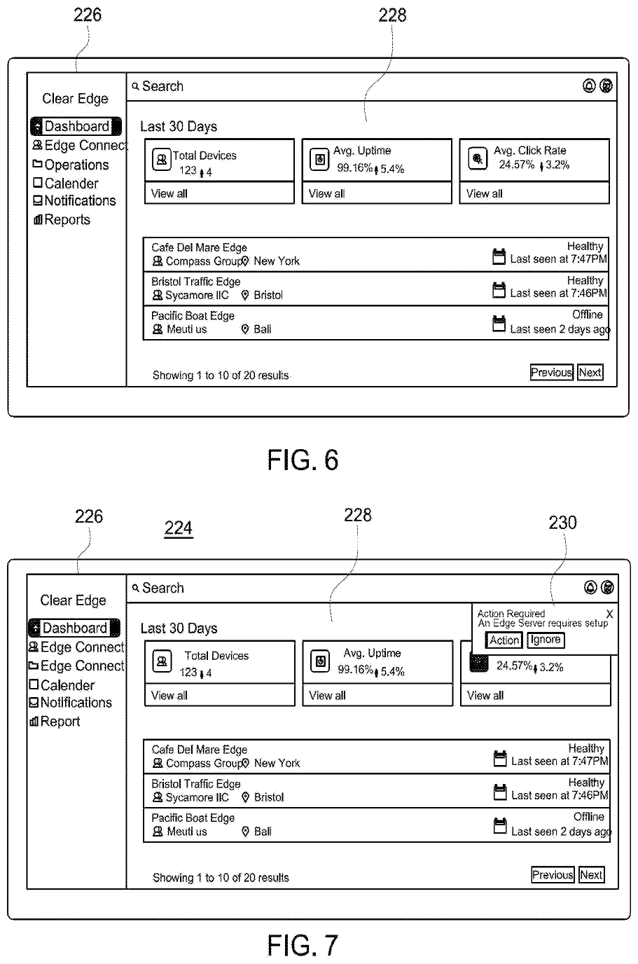

FIG. 6 depicts a screen 224 that is displayed on a browser 226 that illustrates a main dashboard 228. The main dashboard 228 provides a user with the ability to view of key performance indices (KPIs) across all edge devices, such as the edge devices 110-118 shown in FIGS. 1-2. The main dashboard 228 has the ability to display other similar information and the ability to navigate to view other areas in which the system 100 shown in FIGS. 1-3 is operating.

FIG. 7 depicts the screen 224 on the browser 226 that includes the main dashboard 228. In this exemplary embodiment, a notification 230 that can appear when a user is using the system 100 shown in FIGS. 1-3. The dashboard 228 can function as a management console that makes it possible for user to manage multiple deployed computer vision systems from a single location.

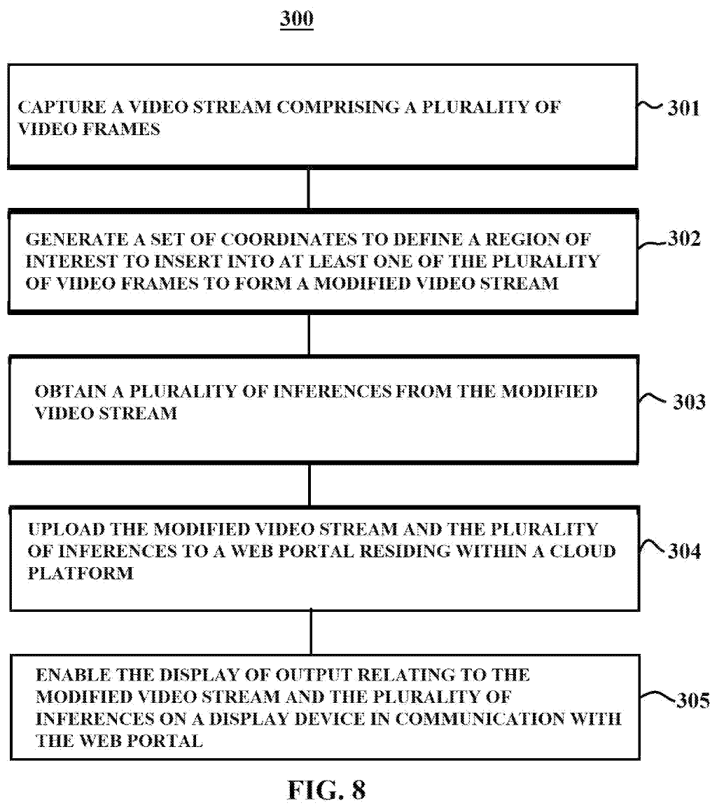

Referring now to FIG. 8 with continuing reference to the foregoing figures, another embodiment of a video analysis system, generally designated by the numeral 300, is shown. Like the embodiment shown in FIGS. 1-2, the system 300 includes a plurality of edge devices 310-318, a cloud platform 320, and a computing device 322 having a browser 324 and a configuration application 326. As shown in FIG. 8, the system 300 can include an interface 328 that connects to a control system 330. The cloud platform 320 includes a message broker 332.

Unlike the embodiment shown in FIGS. 1-2, the edge devices 310-318 communicate with the cloud platform 320 through a video hub 334. The video hub 334 includes a TURN (Traversal Using Relays around NAT) and STUN (Session Traversal Utilities for NAT) server 336 and a streaming server 338. In this exemplary embodiment, the streaming server 338 is a Janus WebRTC server developed by Meetecho of Napoli, Italy.

The TURN and STUN sever 336 provide security to the system 300 to ensure that the cloud platform 320 can confirm that communications that originate from the edge devices 310-318 are genuine and that the edge devices 310-318 should have access to the system 300. The TURN and STUN server 336 can further ensure a direct connection from the video hub 334 to the edge devices 310-318.

The steaming server 338 can support video streaming through the cloud platform 320 to users through computing devices, such as computing device 322. The streaming server 338 can produce a single stream to the computing device 322.

The video hub 334 can include a multimedia framework 340, such as a pipeline-based multimedia framework that links together a wide variety of media processing systems to complete complex workflows. In this exemplary embodiment, the multimedia framework 340 can be gstreamer hosted on freedesktop.org.

The multimedia framework 340 can include modules, such as a mixer module than can mesh two different video streams together. The multimedia framework 340 can mesh all output into a single video stream.

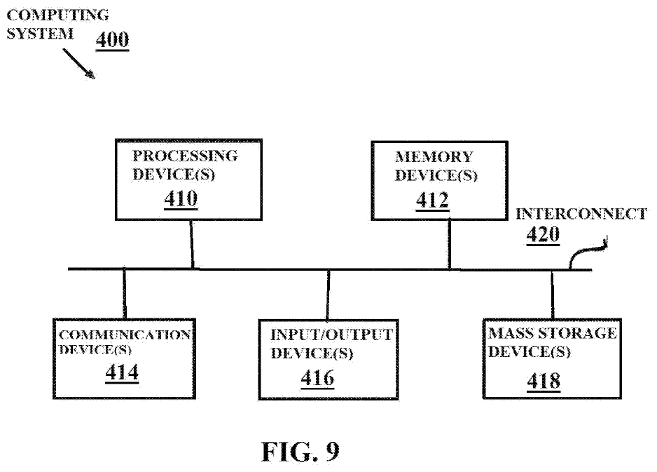

Referring to FIG. 9 with continuing reference to the foregoing figures, an exemplary process, generally designated by the numeral 400, for performing video analysis is shown. The process 300 can be a performed within the system 100 shown in FIGS. 1-3 and/or using a similar system to produce output shown on screen 200 shown in FIG. 4.

At 401, a video stream comprising a plurality of video frames is captured with a camera. In this exemplary embodiment, the camera can be one of the cameras 138-140 shown in FIG. 2.

At 402, a set of coordinates to define a region of interest is generated with a processor to insert into at least one of the plurality of video frames to form a modified video stream. In this exemplary embodiments, the coordinates can be the coordinates 152-158 shown in FIG. 3. The region of interest can be the region 160 shown in FIG. 3.

At 403, a plurality of inferences from the modified video stream are obtained with the processor. In this exemplary embodiment, the inferences can be obtained from the inference module 148 on the edge device 110 shown in FIG. 2.

At 404, the modified video stream and the plurality of inferences are uploaded to a web portal residing within a cloud platform. In this exemplary embodiment, the web portal can be the web portal 128 shown in FIG. 1. The cloud platform can be the cloud platform 120 shown in FIG. 1.

At 405, the display of output relating to the modified video stream and the plurality of inferences is enabled, with the cloud platform, on a display device in communication with the web portal. In this exemplary embodiment, the display device can be the computing device 122 shown in FIG. 1.

### Exemplary Computing Devices

Referring now to FIG. 10 with continuing reference to the forgoing figures, an exemplary computing system, generally designated by the numeral 500, for use by the system 100 shown in FIGS. 1-3, the screen 200 shown in FIG. 4, and/or the system 300 shown in FIG. 8. The system 500 can be used to practice the process 400 shown in FIG. 9.

The hardware architecture of the computing system 500 that can be used to implement any one or more of the functional components described herein. In some embodiments, one or multiple instances of the computing system 500 can be used to implement the techniques described herein, where multiple such instances can be coupled to each other via one or more networks.

The illustrated computing system 500 includes one or more processing devices 510, one or more memory devices 512, one or more communication devices 514, one or more input/output (I/O) devices 516, and one or more mass storage devices 518, all coupled to each other through an interconnect 520. The interconnect 520 can be or include one or more conductive traces, buses, point-to-point connections, controllers, adapters, and/or other conventional connection devices. Each of the processing devices 510 controls, at least in part, the overall operation of the processing of the computing system 500 and can be or include, for example, one or more general-purpose programmable microprocessors, digital signal processors (DSPs), mobile application processors, microcontrollers, application-specific integrated circuits (ASICs), programmable gate arrays (PGAs), or the like, or a combination of such devices.

Each of the memory devices 512 can be or include one or more physical storage devices, which can be in the form of random access memory (RAM), read-only memory (ROM) (which can be erasable and programmable), flash memory, miniature hard disk drive, or other suitable type of storage device, or a combination of such devices. Each mass storage device 518 can be or include one or more hard drives, digital versatile disks (DVDs), flash memories, or the like. Each memory device 512 and/or mass storage device 518 can store (individually or collectively) data and instructions that configure the processing device(s) 510 to execute operations to implement the techniques described above.

Each communication device 514 can be or include, for example, an Ethernet adapter, cable modem, Wi-Fi adapter, cellular transceiver, baseband processor, Bluetooth or Bluetooth Low Energy (BLE) transceiver, serial communication device, or the like, or a combination thereof. Depending on the specific nature and purpose of the processing devices 510, each I/O device 516 can be or include a device such as a display (which can be a touch screen display), audio speaker, keyboard, mouse or other pointing device, microphone, camera, etc. Note, however, that such I/O devices 516 can be unnecessary if the processing device 510 is embodied solely as a server computer.

In the case of a client device (e.g., edge device), the communication devices(s) 514 can be or include, for example, a cellular telecommunications transceiver (e.g., 3G, LTE/4G, 5G), Wi-Fi transceiver, baseband processor, Bluetooth or BLE transceiver, or the like, or a combination thereof. In the case of a server, the communication device(s) 514 can be or include, for example, any of the aforementioned types of communication devices, a wired Ethernet adapter, cable modem, DSL modem, or the like, or a combination of such devices.

A software program or algorithm, when referred to as “implemented in a computer-readable storage medium,” includes computer-readable instructions stored in a memory device (e.g., memory device(s) 512). A processor (e.g., processing device(s) 510) is “configured to execute a software program” when at least one value associated with the software program is stored in a register that is readable by the processor. In some embodiments, routines executed to implement the disclosed techniques can be implemented as part of OS software (e.g., MICROSOFT WINDOWS® and LINUX®) or a specific software application, algorithm component, program, object, module, or sequence of instructions referred to as “computer programs.”

Computer programs typically comprise one or more instructions set at various times in various memory devices of a computing device, which, when read and executed by at least one processor (e.g., processing device(s) 510), will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium (e.g., the memory device(s) 512).

### Supported Features and Embodiments

The detailed description provided above in connection with the appended drawings explicitly describes and supports various features of a video analysis system. By way of illustration and not limitation, supported embodiments include a video analysis system comprising: a cloud platform having a message broker and a web portal thereon; and an edge device connects to the cloud platform and has a camera, memory for storing computer readable instructions, and a processor for executing the computer readable instructions, the computer readable instructions including instructions for: capturing, from the camera, a video stream comprising a plurality of video frames; generating a set of coordinates to define a region of interest to insert into at least one of the plurality of video frames to form a modified video stream; processing the modified video stream with an inference module to obtain a plurality of inferences; and sending the modified video stream and the plurality of inferences to the cloud platform web portal to display output relating to the modified video stream and the plurality of inferences thereon.

Supported embodiments include the foregoing video analysis system, wherein the plurality of inferences include inferences corresponding to at least one detected object within the region of interest.

Supported embodiments include any of the foregoing video analysis systems, wherein the output includes output indicating that an object has been detected within the region of interest.

Supported embodiments include any of the foregoing video analysis systems, wherein the computer readable instructions include instructions for generating analytics based upon the object within the region of interest.

Supported embodiments include any of the foregoing video analysis systems, wherein the computer readable instructions include instructions for inserting at least one segment around the detected object into at least one of the plurality of frames.

Supported embodiments include any of the foregoing video analysis systems, wherein the computer readable instructions include instructions for generating analytics based upon the object within the region of interest based upon input from a user.

Supported embodiments include any of the foregoing video analysis systems, wherein the camera is one of a plurality of cameras with each camera sending a video signal to a mux, so that the mux can form the video stream by combining the video signals.

Supported embodiments include any of the foregoing video analysis systems, wherein the computer readable instructions include instructions for identifying an event within the region of interest.

Supported embodiments include any of the foregoing video analysis systems, wherein the computer readable instructions include instructions for communicating with an interface that is connected to a control system.

Supported embodiments include any of the foregoing video analysis systems, wherein the computer readable instructions include instructions for sending commands to the control system through the interface.

Supported embodiments include any of the foregoing video analysis systems, wherein the edge device memory includes rules for determining when an event has occurred.

Supported embodiments include any of the foregoing video analysis systems, wherein the edge device can receive input from a user to modify the rules.

Supported embodiments include any of the foregoing video analysis systems, wherein the computer readable instructions include instructions for sending an alert when an event is identified within the region of interest.

Supported embodiments include any of the foregoing video analysis systems, wherein the cloud platform includes a turn server.

Supported embodiments include any of the foregoing video analysis systems, wherein the cloud platform includes a webrtc enabling application.

Supported embodiments include a method for facilitating video analysis comprising: capturing, from a camera, a video stream comprising a plurality of video frames; generating, with a processor, a set of coordinates to define a region of interest to insert into at least one of the plurality of video frames to form a modified video stream; obtaining, with the processor, a plurality of inferences from the modified video stream; uploading the modified video stream and the plurality of inferences to a web portal residing within a cloud platform; and enabling, with the cloud platform, the display of output relating to the modified video stream and the plurality of inferences on a display device in communication with the web portal.

Supported embodiments include the foregoing method, further comprising: detecting objects within the region of interest; and generating output relating to the objects.

Supported embodiments include any of the foregoing methods, further comprising: inserting at least one segment around the object into at least one of the plurality of frames.

Supported embodiments include any of the foregoing methods, further comprising: generating analytics relating to the region of interest for display on the display device in response to queries from a user.

Supported embodiments include any of the foregoing methods, further comprising: identifying an event within the region of interest.

Supported embodiments include any of the foregoing methods, further comprising: communicating with an interface that is connected to a control system.

Supported embodiments include any of the foregoing methods, further comprising: sending commands to the control system through the interface.

Supported embodiments include any of the foregoing methods, further comprising: controlling the control system with rules stored in memory on an edge device.

Supported embodiments include any of the foregoing methods, further comprising: modifying the rules in response to input received from a user.

Supported embodiments include any of the foregoing methods, further comprising: sending an alert when an event is identified within the region of interest.

Supported embodiments include a device, an apparatus, a computer-readable storage medium, a computer program product and/or means for implementing any of the foregoing systems, methods, or portions thereof.

Supported embodiments includes a management console that makes it possible for a user to manage multiple deployed computer vision systems from a single location. This feature overcomes the limitations of conventional systems that deploy edge devices that function as self-contained pilots.

Through the use of the management console, a production plant manager can view the status of and control a fleet of programmable logic controller (PLC), programmable automation controller (PAC) devices, and other devices from a single console. Such systems are suitable for environments that require production scale.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

1. A video analysis system comprising:
a cloud platform having a message broker, webrtc enabling application, and a web portal thereon; and
an edge device connects to the cloud platform and has a camera thereon, memory for storing computer readable instructions, and a processor for executing the computer readable instructions, the computer readable instructions including instructions for:
capturing, from the camera, a video stream comprising a plurality of video frames;
generating a set of coordinates to define a region of interest to insert into at least one of the plurality of video frames to form a modified video stream;
processing the modified video stream with an inference module to obtain a plurality of inferences; and
sending, through the webrtc enabling application, the modified video stream and the plurality of inferences to the cloud platform web portal to display output relating to the modified video stream and the plurality of inferences thereon.

2. The video analysis system of claim 1, wherein the plurality of inferences include inferences corresponding to at least one detected object within the region of interest.

3. The video analysis system of claim 2, wherein the output includes output indicating that an object has been detected within the region of interest.

4. The video analysis system of claim 3, wherein the computer readable instructions include instructions for generating analytics based upon the object within the region of interest.

5. The video analysis system of claim 2, wherein the computer readable instructions include instructions for inserting at least one segment around the detected object into at least one of the plurality of frames.

6. The video analysis system of claim 3, wherein the computer readable instructions include instructions for generating analytics based upon the object within the region of interest based upon input from a user.

7. The video analysis system of claim 1, wherein the camera is one of a plurality of cameras with each camera sending a video signal to a mux, so that the mux can form the video stream by combining the video signals.

8. The video analysis system of claim 1, wherein the computer readable instructions include instructions for identifying an event within the region of interest.

9. The video analysis system of claim 8, wherein the computer readable instructions include instructions for communicating with an interface that is connected to a control system and instructions for sending commands to the control system through the interface.

10. (canceled)

11. The video analysis system of claim 8, wherein the edge device memory includes rules for determining when an event has occurred; and
wherein the edge device can receive input from a user to modify the rules.

12. (canceled)

13. The video analysis system of claim 8, wherein the computer readable instructions include instructions for sending an alert when an event is identified within the region of interest.

14. The video analysis system of claim 1, wherein the cloud platform includes a turn server, the video analysis system further comprising:
a computing device having a browser thereon;
wherein the cloud platform sends output relating to the modified video stream and the plurality of inferences to the computing device for display through the browser.

15. (canceled)

16. A method for facilitating video analysis comprising:
capturing, from a camera, a video stream comprising a plurality of video frames;
generating, with a processor, a set of coordinates to define a region of interest to insert into at least one of the plurality of video frames to form a modified video stream;
obtaining, with the processor, a plurality of inferences from the modified video stream;
uploading the modified video stream and the plurality of inferences to a web portal residing within a cloud platform;
sending, through the webrtc enabling application, the modified video stream and the plurality of inferences to the web portal; and
enabling, with the cloud platform, the display of output relating to the modified video stream and the plurality of inferences on a display device in communication with the web portal.

17. The method of claim 16, further comprising:
detecting objects within the region of interest; and
generating output relating to the objects.

18. The method of claim 17, further comprising:
inserting at least one segment around the object into at least one of the plurality of frames.

19. The method of claim 16, further comprising:
generating analytics relating to the region of interest for display on the display device in response to queries from a user.

20. The method of claim 16, further comprising:
identifying an event within the region of interest;
communicating with an interface that is connected to a control system;
sending commands to the control system through the interface;
controlling the control system with rules stored in memory on an edge device; and
modifying the rules in response to input received from a user.

24. 21-24 (canceled)

25. The method of claim 20, further comprising:
sending an alert when an event is identified within the region of interest.

26. A video analysis system comprising:
a cloud platform having a message broker and a web portal thereon; and
a plurality of edge devices connect to the cloud platform with each of the plurality of edge devices having a camera thereon, memory for storing computer readable instructions, and a processor for executing the computer readable instructions, the computer readable instructions including instructions for:
capturing, from each of the cameras, a plurality of video streams with each of the plurality of video streams comprising a plurality of video frames;
generating a set of coordinates to define a region of interest to insert into at least one of the plurality of video frames to form a modified video stream;
processing the modified video stream with an inference module to obtain a plurality of inferences; and
sending, through a webrtc enabling application, the modified video stream and the plurality of inferences to the cloud platform web portal to display output relating to the modified video stream and the plurality of inferences thereon.

27. The video analysis system of claim 26, further comprising a computing device for connecting to the cloud devices with the computing device having a browser for displaying a management console for controlling the plurality of edge devices.
